(19) United States
(12) Patent Application Publication
(10) Pub. No.: US 2026/0073931 A1
(43) Pub. Date: Mar. 12, 2026

(54) Systems And Methods Of Jointly Optimized Uplink Downlink Audio Processing

(71) Applicant: Agora Lab, Inc., Santa Clara, CA (US)

(72) Inventors: Siqiang Yao, Shanghai (CN); Sen Li, San Diego, CA (US); Guangjian Xu, Shanghai (CN); Ruofei Chen, Shanghai (CA)

(21) Appl. No.: 18/883,416

(22) Filed: Sep. 12, 2024

(30) Foreign Application Priority Data
Aug. 28, 2024 (CN) 2024111954657

(51) Int. Cl. G10L 21/0232; G10L 21/0208; G10L 25/84

(52) U.S. Cl. CPC G10L 21/0232; G10L 25/84; G10L 2021/02082

(57) ABSTRACT

A method of processing audio is disclosed. The method includes capturing, via a recording device of an apparatus, an audio signal, wherein the audio signal includes background noise. The method also includes determining, at an uplink stage by a processor, whether the audio signal includes a voice segment of a speaker, and filtering, initially during the uplink stage, the audio signal to suppress or eliminate the background noise. The method further includes determining, by the processor, one or more parameters associated with the audio signal, and responsive to receiving the one or more parameters, filtering, at the downlink stage and based on the one or more parameters, an audio source associated with the audio signal that is played through a playback device of the apparatus during capturing of the audio signal, whereby the audio source includes the background noise of the audio signal captured by the recording device.

### TECHNICAL FIELD

This disclosure relates to audio processing, and in particular, to optimizing audio filtering of an audio signal captured by a recording device and/or optimizing audio filtering of an audio signal for playback by a device.

### BACKGROUND

Communication may frequently occur online over various communication channels and via many media types. By way of example, such an interaction may be real-time communication (RTC) using audio and/or video conferencing or streaming or, in some circumstances, simple telephone voice calls. The audio and/or video communication may be or may include speech, voice (e.g., singing), visual content, or a combination thereof. Such RTC may include one or more users (i.e., one or more sending users) that may transmit (e.g., the audio and/or the video) to one or more receiving users. For example, a concert may be live streamed to many viewers. In another example, a sending user or users (e.g., multiple users simultaneously) may sing a song (e.g., karaoke) that may be live-streamed to viewers, whereby the live-stream may include both the singing voice of the sending user or users and the underlying music thereof.

In RTC, some users may wish to improve the audio quality being transmitted. For example, users may wish to decrease or eliminate buffering, audio playback glitching due to audio sound packet loss, jitter, or a combination thereof caused by unstable network conditions. Similarly, users may wish to decrease or eliminate background noise prior to playback of the audio being transmitted.

### SUMMARY

In one aspect, a method of processing audio is disclosed. The method includes capturing, via a recording device of an apparatus, an audio signal, wherein the audio signal includes background noise. The method also includes determining, at an uplink stage by a processor, whether the audio signal includes a voice segment of a speaker, and filtering, initially during the uplink stage, the audio signal to suppress or eliminate the background noise. The method further includes determining, by the processor, one or more parameters associated with the audio signal, and responsive to receiving the one or more parameters, filtering, at a downlink stage and based on the one or more parameters, an audio source associated with the audio signal that is played through a playback device of the apparatus during capturing of the audio signal, whereby the audio source includes the background noise of the audio signal captured by the recording device.

In another aspect, an apparatus for processing audio is disclosed. The apparatus includes a non-transitory memory and a processor configured to execute instructions stored in the non-transitory memory. The instructions stored in the non-transitory memory include instructions to capture, via a recording device of the apparatus, an audio signal, wherein the audio signal includes background noise. The instructions stored in the non-transitory memory also include instructions to determine, at an uplink stage by the processor, whether the audio signal includes a voice segment of a speaker, and filter, initially during the uplink stage, the audio signal to suppress or eliminate the background noise. The instructions stored in the non-transitory memory also include instructions to determine, by the processor, one or more parameters associated with the audio signal, and responsive to receiving the one or more parameters, filter, at a downlink stage and based on the one or more parameters, an audio source associated with the audio signal that is played through a playback device of the apparatus during capturing of the audio signal, whereby the audio source includes the background noise of the audio signal captured by the recording device.

In another aspect, a non-transitory computer-readable storage medium is disclosed. The non-transitory computer-readable storage medium is configured to store computer programs for processing audio. The computer programs include instructions executable by the processor. The instructions executable by the processor include instructions to capture, via a recording device of an apparatus, an audio signal, wherein the audio signal includes background noise. The computer programs include instructions executable by the processor to determine, at an uplink stage by the processor, whether the audio signal includes a voice segment of a speaker and filter, initially during the uplink stage, the audio signal to suppress or eliminate the background noise. The computer programs include instructions executable by the processor to determine, by the processor, one or more parameters associated with the audio signal, and responsive to receiving the one or more parameters, filter, at a downlink stage and based on the one or more parameters, an audio source associated with the audio signal that is played through a playback device of the apparatus during capturing of the audio signal, whereby the audio source includes the background noise of the audio signal captured by the recording device.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a diagram of an example of a system for media transmission.

FIG. 2 is a diagram of an example of a real-time audio communications system.

FIG. 3 is a diagram of an example of a real-time audio communications system for processing audio recordings.

FIG. 4 is a diagram of another example of the real-time audio communications system of FIG. 3 for processing audio recordings that include a voice of a speaker.

FIG. 5 is a flowchart of an example of a technique for processing audio recordings.

FIG. 6 is a flowchart of an example of a technique for processing audio recordings.

### DETAILED DESCRIPTION

An audio communication system may include a sender (i.e., a sending device) and a receiver (i.e., a receiving device). The sender may perform at least some of the steps of audio capturing, audio conversion (e.g., converting an analog audio signal into a digital format), audio encoding, and audio transmission. For example, the sender may be a client device that captures and transmits (e.g., streams) audio (e. g, an audio signal) in real-time to one or more receivers. In another example, the sender may be a streaming server, which may include real-time audio or pre-recorded audio to be streamed to one or more receivers. The receivers may thus perform the steps of audio decoding, audio decompression, audio conversion (e.g., converting the digital format into the original analog audio signal), and audio transmission to one or more playback devices (e.g., headphones, speakers, etc.) Thus, based on the above, the sender may be or may contain an encoder and the receiver may be or may contain a decoder. Additionally, the sender and receiver may communicate over a network. That is, the encoded audio data may be transmitted from the sender to the receiver over the network. For example, the audio data may be transmitted from the sender to the receiver via multiple servers of the network.

The audio captured may be any type of sound waves captured by the sender (e.g., a microphone of the sender). By way of example, the audio captured may be a voice (e.g., a voice segment) of a user of the sender. The voice (e.g., voice segment) captured may be talking by the user and/or singing by the user. In some instances, the sender may also play audio (e.g., music, singing, other audio, etc.), such as through a playback device of the sender (e.g., headphones, speakerphone, earpiece, or external speaker), whereby the audio captured by the sender may also include a portion of the audio played by the sender. That is, the audio captured (e.g., recorded) by the sender may include an echo of the audio played through the playback device of the sender.

The teachings herein are not limited to only capturing a voice of a user. For example, the audio captured or otherwise obtained by the sender may be live stream audio data or pre-recorded audio data, such as a music file, an audiobook, a presentation, the like, or a combination thereof. Additionally, it should be noted that while audio communication is described herein, video communication is also contemplated. That is, the audio transmitted from the sender to the receiver may be transmitted in conjunction with video data (e.g., a video conference and/or video stream that may include an audio component).

Different techniques are known for encoding and decoding audio. For example, audio data may be encoded/decoded using analog-to-digital conversion (ADC), in which continuous analog audio signals may be converted into discrete digital samples. In such an encoding/decoding, snapshots of the continuous analog audio signals may be taken at regular intervals and assigned digital values, whereby the converted digital audio data may then be converted back to the continuous analog signal for audio playback by the receiver.

Additionally, audio data may be compressed using one or more compression algorithms (e.g., lossless and/or lossy compression, such as Free Lossless Audio Codec (FLAC), MP3, etc.), whereby the compressed audio data may be decompressed by the receiver for audio playback. Moreover, when audio data is transmitted in a digital format, the digital audio data may be divided into segments (e.g., packets) for transmission over a network. In such a case, each packet may contain a portion of the audio data along with additional information for synchronization and/or error correction (e.g., correction to avoid packet loss, jitter, etc.).

Moreover, audio data (e.g., audio recordings, other audio data files, etc.) may be processed using one or more filter modules to improve an overall quality of the underlying audio signal within the audio data. By way of example, an audio communications system, such as an audio communications system configured for real-time communication (RTC), may include one or more filter modules. The one or more filter modules may filter audio data as it is recorded by the sender prior to transmission of the audio data to a central system (e.g., a central system of the sender) and/or transmission of the audio data to the receiver. That is, the one or more filter modules may filter the audio data during uplink (i.e., an uplink stage). Similarly, the one or more filter modules may filter audio data after transmission of the audio data to the central system (e.g., the central system of the sender) and/or transmission of the audio data to the receiver. That is, the one or more filter modules may filter the audio data during downlink (i.e., a downlink stage).

The above techniques for audio transmission may be conventionally used to encode, transmit, and decode audio data in real-time communication (RTC) over a network. For example, for live-stream karaoke applications, a singer may sing into a microphone of a device (i.e., the sender) so that the device may capture the singing as audio data, encode the audio data, transmit the audio data to an audience (e.g., one or more users of receivers), and play back the audio data so that the audience may listen, in real-time, to the singing of the singer. In such a scenario, the singer may also play the associated music through a speaker of the device (i.e., the sender) to sing along with the music during recording. The music played through the speaker of the device may frequently played at a higher volume and, as a result, the audio captured by the device (i.e., the sender) may frequently include both the singing of the singer and background noise (e.g., echo) caused by the music played through the speaker of the device.

Due to the background noise frequently present in such a recording, audio quality may be poor for the audience listening at the receiver. For example, the background noise caused by the music playing through the device may distort the singing or otherwise impair the singing recorded by the device. Similarly, the one or more filter modules may over-filter or under-filter the audio recorded (e.g., an audio signal of the singing and the background noise combined) in an attempt to suppress or eliminate the background noise. As a result, the singing may also be over-filtered or under-filtered, thereby creating a suppressed singing and/or leaving significant background noise. Such impaired audio may thus be transmitted to the audience and negatively impact the listening experience. Such challenges may be even more prevalent in certain communication conditions, such as in RTC, whereby the audio is transmitted from the sender to the receiver in real time.

Implementations according to this disclosure can reduce the audio degradation described above. Audio recording and audio processing may be completed in a manner that filters background noise without negatively impacting the singing recorded. In particular, the implementations according to this disclosure may improve the singing recorded for an overall improved listening experience for the audience. Audio processing may be completed such that filtering (e.g., filtering modules) of the audio at an uplink stage may communicate with filtering (e.g., filtering modules) at a downlink stage. For example, in RTC, filtering (e.g., based upon one or more filtering parameters) of the audio recorded may be completed at the uplink stage and communicated to the downlink stage such that filtering of an audio source played through the speaker of the sender (e.g., music) may be adjusted. That is, filtering of the music played through the device may be based upon feedback provided by filtering of the audio recorded.

To describe some implementations in greater detail, reference is first made to examples of hardware and software structures used to implement a real-time audio communication system. It should be noted that the teachings herein are not limited to real-time audio communication systems and the real-time audio communication systems described herein are intended for illustrative purposes only due to their typical strain on network bandwidth consumption of a network. As such, the teachings herein may be implemented with any audio and/or video communication system.

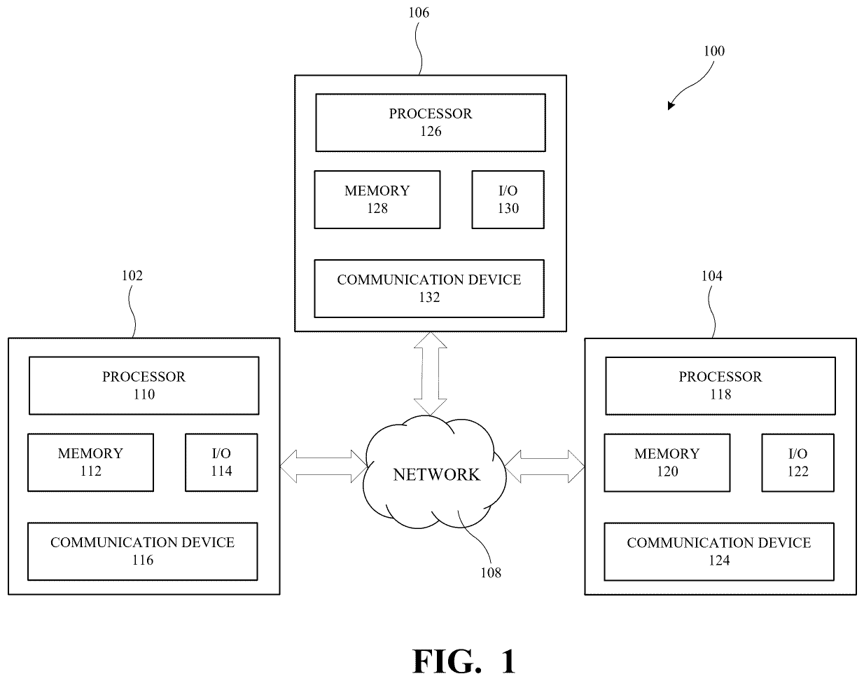

FIG. 1 is a diagram of an example of a system 100 for media transmission, including the transmission of real-time audio data. As shown in FIG. 1, the system 100 may include multiple apparatuses and networks, such an apparatus 102, an apparatus 104, an apparatus 106, and a network 108.

The apparatuses may be implemented by any configuration of one or more computers, such as a microcomputer, a mainframe computer, a supercomputer, a general-purpose computer, a special-purpose/dedicated computer, an integrated computer, a database computer, a remote server computer, a personal computer, a laptop computer, a tablet computer, a cell phone, a personal data assistant (PDA), a wearable computing device, or a computing service provided by a computing service provider (e.g., a web host or a cloud service provider). In some implementations, an apparatus may be implemented in the form of multiple groups of computers that are at different geographic locations and may communicate with one another, such as by way of a network. While certain operations may be shared by multiple computers, in some implementations, different computers may be assigned to different operations. In some implementations, the system 100 may be implemented using general-purpose computers/processors with a computer program that, when executed, carries out any of the respective techniques, algorithms, and/or instructions described herein. In addition, or alternatively, for example, special-purpose computers/processors including specialized hardware may be utilized for carrying out any of the methods, algorithms, or instructions described herein.

The apparatus 102 may have an internal configuration of hardware including a processor 110 and a memory 112. The processor 110 may be any type of device or devices capable of manipulating or processing information. In some implementations, the processor 110 may include a central processor (e.g., a central processing unit or CPU). In some implementations, the processor 110 may include a graphics processor (e.g., a graphics processing unit or GPU). Although the examples herein may be practiced with a single processor as shown, advantages in speed and efficiency may be achieved using more than one processor. For example, the processor 110 may be distributed across multiple machines or devices (each machine or device having one or more processors) that may be coupled directly or connected via a network (e.g., a local area network).

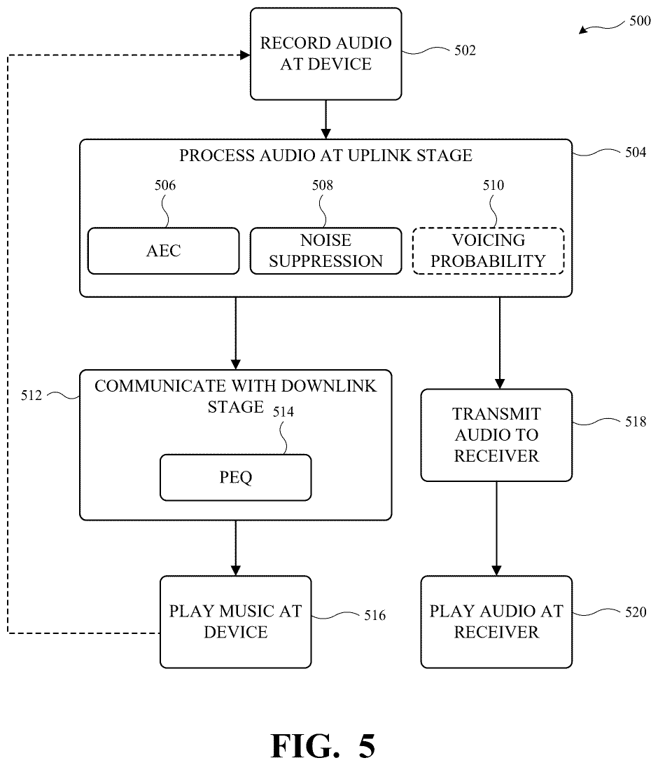

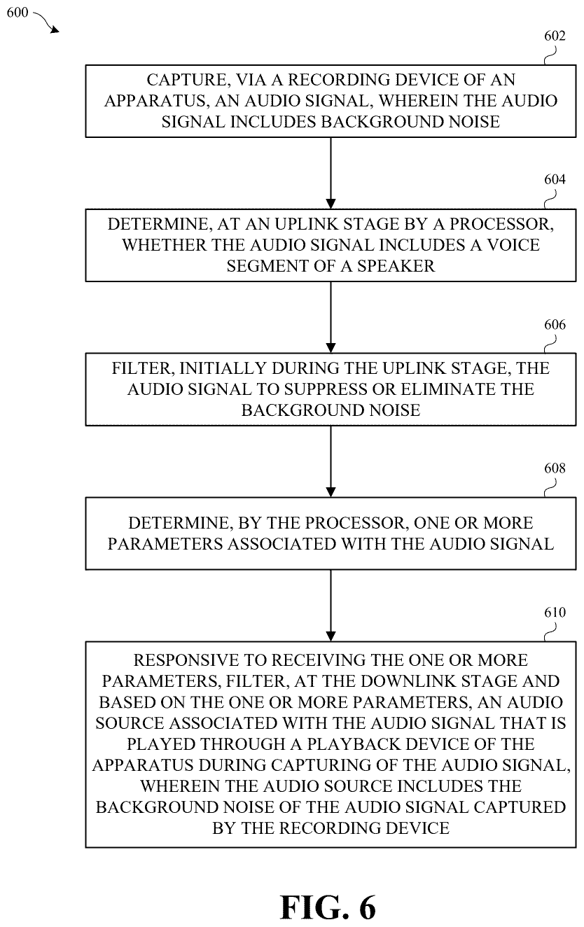

The memory 112 may include any transitory or non-transitory device or devices capable of storing codes (e.g., instructions) and data that may be accessed by the processor (e.g., via a bus). The memory 112 may be a random-access memory (RAM) device, a read-only memory (ROM) device, an optical/magnetic disc, a hard drive, a solid-state drive, a flash drive, a security digital (SD) card, a memory stick, a compact flash (CF) card, or any combination of any suitable type of storage device. In some implementations, the memory 112 may be distributed across multiple machines or devices, such as in the case of a network-based memory or cloud-based memory. The memory 112 may include data (not shown), an operating system (not shown), and one or more applications (not shown). The data may include any data for processing (e.g., an audio stream, a wide-angle video stream, or a multimedia stream). At least one of the applications may include programs that permit the processor 110 to implement instructions to generate control signals for performing functions of the techniques in the following description. For example, when functioning as a sender and/or a receiver, the applications may include instructions for performing at least the techniques described with respect to FIGS. 5 and 6.

In some implementations, in addition to the processor 110 and the memory 112, the apparatus 102 may also include a secondary (e.g., external) storage device (not shown). The secondary storage device may be a storage device in the form of any suitable non-transitory computer-readable medium, such as a memory card, a hard disk drive, a solid-state drive, a flash drive, or an optical drive. Further, the secondary storage device may be a component of the apparatus 102 or may be a shared device accessible via a network. In some implementations, the application in the memory 112 may be stored in whole or in part in the secondary storage device and loaded into the memory 112 as needed for processing.

The apparatus 102 may include input/output (I/O) devices. For example, the apparatus 102 may include an I/O device 114. The I/O device 114 may be implemented in various ways, for example, it may be a microphone that can be coupled to the apparatus 102 and configured to record audio signals in an area surrounding the apparatus 102. The I/O device 114 may be any device capable of transmitting a visual, acoustic, or tactile signal to a user, such as a display, a touch-sensitive device (e.g., a touchscreen), a speaker, an earphone, a light-emitting diode (LED) indicator, or a vibration motor. The I/O device 114 may also be any type of input device either requiring or not requiring user intervention, such as a keyboard, a numerical keypad, a mouse, a trackball, a microphone, a touch-sensitive device (e.g., a touchscreen), a sensor, or a gesture-sensitive input device.

The I/O device 114 may alternatively or additionally be formed of a communication device for transmitting signals and/or data. For example, the I/O device 114 may include a wired means for transmitting signals (e.g., audio signals) or data (e.g., audio data) from the apparatus 102 to another device. For another example, the I/O device 114 may include a wireless transmitter or receiver using a protocol compatible to transmit signals from the apparatus 102 to another device or to receive signals from another device to the apparatus 102.

The apparatus 102 may include a communication device 116 to communicate with another device. The communication may be via the network 108. The network 108 may be one or more communications networks of any suitable type in any combination, including, but not limited to, networks using Bluetooth communications, infrared communications, near field connections (NFCs), wireless networks, wired networks, local area networks (LANs), wide area networks (WANs), virtual private networks (VPNs), cellular data networks, or the Internet. The communication device 116 may be implemented in various ways, such as via a transponder/transceiver device, a modem, a router, a gateway, a circuit, a chip, a wired network adapter, a wireless network adapter, a Bluetooth adapter, an infrared adapter, an NFC adapter, a cellular network chip, or any suitable type of device in any combination that is coupled to the apparatus 102 to provide functions of communication with the network 108.

Similar to the apparatus 102, the apparatus 104 may include a processor 118, a memory 120, an I/O device 122, and a communication device 124. The implementations of elements 118-124 of the apparatus 104 may be similar to the corresponding elements 110-116 of the apparatus 102. Additionally, the apparatus 106 may include a processor 126, a memory 128, an I/O device 130, and a communication device 132. The implementations of elements 126-132 of the apparatus 106 may be similar to the corresponding elements 110-116 of the apparatus 102 and the corresponding elements 118-124 of the apparatus 104.

Each of the apparatus 102, the apparatus 104, and the apparatus 106 may be, such as at different times of a real-time communication session, a receiving device (i.e., a receiver) or a sending device (i.e., a sender). A receiver may perform decoding operations, such as of audio streams as described herein. As such, the receiver may also be referred to as a decoding apparatus or device and may include or be a decoder. A sender may also be referred to as an as an encoding apparatus or device and may include or be an encoder. Additionally, the apparatus 102, the apparatus 104, and the apparatus 106 may communicate with one another via the network 108.

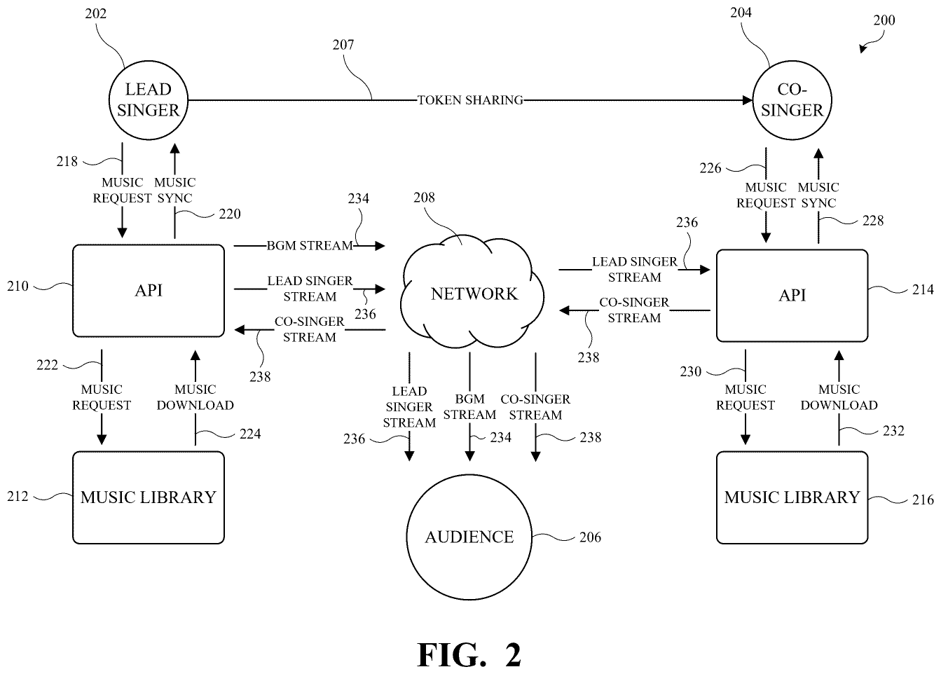

FIG. 2 is a diagram of an example of a real-time audio communications system 200. In particular, the example shown in FIG. 2 illustrates a real-time audio communication system for “Karaoke Television” (KTV). However, such a system may be implemented for other means of real-time audio communication.

As shown in FIG. 2, the system 200 may include multiple singers and multiple audiences in communication over various networks. For example, the system 200 may include a lead singer 202, a co-singer 204, and an audience 206 in communication via a network 208. For illustrative purposes, the lead singer 202 may use or may be part of the apparatus 102, the co-singer may use or may be part of the apparatus 104, and the audience may use or may be a part of the apparatus 106. Based on the above arrangement, the lead singer 202 and the co-singer 204 may, in real-time, sing along to pre-recorded music. For example, the lead singer 202 and the co-singer 204 may be sing along with the pre-recorded music as prompted by lyrics displayed on a display screen of the apparatus 102 and the apparatus 104, respectively. The pre-recorded music may be played through speakers of the apparatus 102 and the apparatus 104. The singing and the pre-recorded music may then, in real-time be transmitted to the audience 206 for listening and/or watching, such as via I/O device 130 of the apparatus 106 (e.g., a speaker and/or display screen).

To facilitate such real-time streaming, the lead singer 202 (e.g., the apparatus 102) may be in communication with, or may execute an application programming interface (API) 210 to coordinate singing of the lead singer 202 with music stored in a music library 212. For example, the apparatus 102 may include the API 210, whereby the API 210 may include a set of rules or protocols that may be stored in the memory 112 and executed by the processor 110. Execution of such rules or protocols may be prompted by user interaction with the apparatus 102, such as via the I/O device 114.

By way of example, the lead singer 202 may interface with a KTV application of the apparatus 102 via the I/O device 114 to select a song to sing along with, as indicated by the music request 218. Based on the music request 218, the apparatus 102 may prompt the API 210 to execute the appropriate rules or protocols so that a music request 222 may be sent to the music library 212. It should be noted that the music library 212 may be stored locally on the apparatus 102 (e.g., stored in the memory 112) or the music library 212 may be stored externally and accessed by the apparatus 102, such as on one or more servers. When the music request 222 is sent to the music library 212, a music download 224 or music stream may be initiated to transmit the desired song from the music library 212 to the apparatus 102 via the API 210. As a result, the lead singer 202 may now be ready to begin singing along with the desired song using the apparatus 102, whereby the desired song may be played by the apparatus 102 for the lead singer 202.

In a similar fashion, the co-singer 204 may interface with a KTV application of the apparatus 104 via the I/O device 122 to select the same song selected by the lead singer 202. To facilitate selection of the same song, the lead singer 202 (e.g., the apparatus 102) may share a token via token sharing 207 with the co-singer 204 (e.g., the apparatus 104) to ensure that both the lead singer 202 and the co-singer have permission to simultaneously select the same song. Based on the token sharing 207, the co-singer may submit a music request 226 that may be similar to the music request 218.

Based on the music request 226, the apparatus 104 may prompt an API 214, which may be similar to the API 210, to execute the appropriate rules or protocols so that a music request 230 may be sent to a music library 216. It should be noted that the music library 216 may be stored locally on the apparatus 104 (e.g., stored in the memory 120) or the music library 216 may be stored externally and accessed by the apparatus 104, such as on one or more servers. In a configuration where the music library 216 is stored externally, the music library 212 and the music library 216 may be a single music library accessed by both the apparatus 102 and the apparatus 104.

When the music request 230 is sent to the music library 216, a music download 232 or music stream may be initiated to transmit the desired song from the music library 216 to the apparatus 104 via the API 214. As a result, the co-singer 204 may also now be ready to being singing along with the desired song using the apparatus 104, whereby the desired song may be played by the apparatus 104 for the co-singer 204. That is, the co-singer 204 and the lead singer 202 may simultaneously sing along with the desired song for real-time streaming. It should also be noted that the co-singer 204 may not be present, at which point the lead singer 202 may complete the above steps for a solo performance (e.g., solo singing).

The singing by the lead singer 202 and the co-singer 204 as described above may be transmitted (e.g., as data representing signing) in real-time to the audience 206 via the network 208. The network 208 may be similar to the network 108 described above. To transmit the singing and music in real-time to the audience 206, a lead singer stream 236, which may contain the singing of the lead singer 202 and the music associated with the singing of lead singer 202, may be transmitted from the lead singer 202 (e.g., from the apparatus 102) to the audience 206 (e.g., to the apparatus 106) via the API 210.

Similarly, a co-singer stream 238, which may contain the singing of the co-singer 204 and the music associated with the singing of the co-singer 204, may be transmitted from the co-singer 204 (e.g., from the apparatus 104) to the audience 206 (e.g., to the apparatus 106) via the API 214. The lead singer stream 236 and the co-singer stream 238 may be transmitted to the audience 206 via the network 208.

Additionally, in certain circumstances, a background music (BGM) stream 234 may also be transmitted from the apparatus 102 (e.g., from the lead singer 202) and/or the apparatus 104 (e.g., the co-singer 204) to the apparatus 106 (e.g., the audience 206) to provide background music at times when the lead singer 202 and the co-singer 204 are not actively live-streaming their singing. Thus, based on the above, multiple participants on multiple devices may be in communication via the network 208 to participate in the KTV stream.

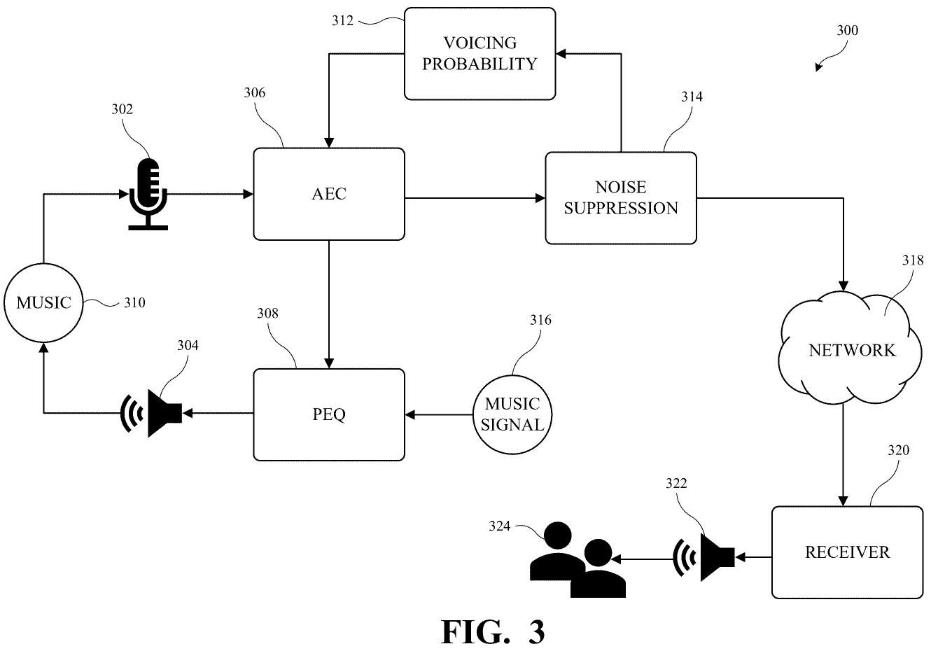

FIG. 3 illustrates an example of a real-time audio communications system 300 for processing audio recordings. The system 300 may be implemented by a sender and/or a receiver, such as the apparatus 102, the apparatus 104, and the apparatus 106 of FIG. 1. That is, the system 300 may be part of the system 100 of FIG. 1. The system 300 may be configured for real-time audio communications, such as KTV as described with respect to FIG. 2. However, the system 300 may be implemented for any type of real-time audio communications.

As shown in FIG. 3, the system 300 may include a recording device 302, such as a microphone. By way of example, the recording device 302 may be the I/O device 114 of the apparatus 102 of FIG. 1. The recording device 302 may record audio (e.g., an audio signal) in a surrounding area, such as a voice of a speaker. For example, the recording device 302 may record singing of the lead singer 202 of FIG. 2. As discussed further below, the audio recorded may then be manipulated, modified, altered, otherwise processed, or a combination thereof such that the audio may then be transmitted to one or more additional devices.

The system 300 may also include a playback device 304, such as a microphone, earphone, headphones, the like, or a combination thereof. By way of example, the playback device 304 may be the I/O device 114 of the apparatus 102 of FIG. 1. That is, the apparatus 102 may include a first I/O device that is the recording device 302 and a second I/O device that is the playback device 304. In such a case, the recording device 302 may be an input device and the playback device 304 may be an output device. In certain implementations, the recording device 302 and the playback device 304 may be—or may be part of—the same I/O device.

The playback device 304 may play audio from a source signal so that a user of the system 300 (e.g., a user of the apparatus 102) may listen to the audio from the source signal. For example, the source signal may be a music signal 316 that may be played through the playback device 304 so that a user (e.g., a singer) may listen to music 310 generated from the music signal 316. However, the source signal may be any audio signal used to generate various audio for the user to hear.

In certain circumstances, such as the KTV example discussed with respect to FIG. 2, the music 310 played through the playback device 304 (e.g., the speaker) may be played at a high volume for the user to hear the music 310 while singing along to the music 310. As a result, the music 310 may be recorded by the recording device 302 alone or together with a voice (e.g., a voice segment) of the user. That is, the music 310 may create background noise for a singer that may be recording their singing to the music 310 such that the recording device 302 may inadvertently record the music 310 or portions thereof.

Similarly, as shown in FIG. 3, a user may be silent (e.g., not singing), such as in between singing portions of the music 310. In such a case, it may be desired to have no audio recorded by the recording device 302 such that any transmitted audio recording is substantially silent. However, due to the music 310 being played through the playback device 304 at a high volume, the music 310 may still be recorded by the recording device 302, thereby creating the background noise.

To resolve the aforementioned issues with background noise caused by the music 310, the system 300 may include one or more filter modules that may be configured to filter out the background noise. The one or more filter modules may process (e.g., filter) the audio (e.g., the audio signal) recorded by the recording device 302 during uplink of the audio. That is, the one or more filter modules may process (e.g., filter) the audio signal after the recording device 302 records the audio signal but prior to transmission of the audio signal to another device (e.g., the apparatus 104 or the apparatus 106 of FIG. 1), which may be considered one or more filter modules of an uplink stage. By way of example, the one or more filter modules of the uplink stage may be an acoustic echo cancellation (AEC) module 306, a voicing probability module 312, and a noise suppression module 314.

The AEC module 306 may be an initial filter of the audio recorded by the recording device 302. The AEC module 306 may be, or may include, components and/or software configured to eliminate acoustic echo, such as echo that may occur due to the music 310 being inadvertently recorded by the recording device 302. The AEC module 306 may be particularly configured eliminate or suppress such echo in real time. That is, the system 300 may be configured for RTC and the AEC module 306 may be adapted for such communication.

The AEC module 306 is not particularly limited to any type of techniques, protocols, or rules. For example, the AEC module 306 may include techniques, protocols, or rules to identify the presence of an echo in the audio recorded (e.g., the presence of the music 310 in the audio recorded), to generate an anti-echo signal configured to align with acoustic characteristics of the echo, to process the audio recorded in real time (i.e., during RTC), or a combination thereof. In any case, it is envisioned that the AEC module 306 may be dynamically adjusted, such as by adjusting one or more parameters of the AEC module 306, based upon feedback provided by downstream and/or upstream modules.

For example, the AEC module 306 may be dynamically adjusted based upon feedback provided by the noise suppression module 314. The noise suppression module 314 implement various techniques or algorithms to reduce or eliminate the background noise created by the music 310. It should also be noted that the background noise discussed herein may also come from sources other than the music 310 played through the playback device 304. The noise suppression module 314 is not particularly limited to any one technique or algorithm. For example, the noise suppression module 314 may include various techniques or algorithms to identify the background noise, to dynamically adjust background noise suppression based on various real-time parameters, to preserve speech or singing within the audio recorded, or a combination thereof. The noise suppression module 314 may also determine one or more parameters, which may then be communicated (e.g., transmitted) to the AEC module 306 to adjust performance of the AEC module 306 for future filtering of the audio recorded.

The AEC module 306 may also be dynamically adjusted based upon feedback received from the voicing probability module 312. The voicing probability module 312 may include—or implement—techniques and/or algorithms to determine the presence of a voice (e.g., the voice of a speaker, such as singing of the singer) within the audio recorded. The voicing probability module 312 is not limited to any one technique or algorithm to determine the presence of the voice. For example, the voicing probability module 312 may use various statistical analysis models (e.g., Mean Square Error (MSE), R², etc.) to determine the likelihood of the presence of the voice. The voicing probability module 312 may also use various speaker recognition models to determine the presence of a voice, such as but not limited to, Gaussian Mixture Models (GMMs), Hidden Markov Models (HMMs), Support Vector Machines (SVMs), neural networks, i-vectors and Probabilistic Linear Discriminant Analysis (PLDA), Dynamic Time Warping (DTW), nearest neighbor models, the like, or a combination thereof.

Feedback may be provided by the voicing probability module 312 to the AEC module 306 based on the above techniques of the voicing probability module 312. That is, one or more parameters of the AEC module 306 may be adjusted based upon whether the voicing probability module 312 detects a voice in the audio recorded or if only the background noise created by the music 310 is detected.

In the example shown in FIG. 3, no user (e.g., singer) is actively recording their voice. That is, the audio (e.g., the audio signal) recorded by the recording device 302 is only background noise caused by the music 310 or other background noise generated by external sources. In such a case, the audio recorded (i.e., the background noise) may be initially processed through the AEC module 306 with default or initial settings, may then be processed through the noise suppression module 314, and then ultimately reach the voicing probability module 312. At this point, the voicing probability module 312 may determine if a voice (e.g., a voice segment) of the user (e.g., a singer) is present in the audio recorded. In the case of FIG. 3, the voicing probability module 312 may determine that no voice is present and relay (e.g., transmit) such information to the AEC module 306.

For example, the AEC module 306 may have different modes of operation, whereby the modes include different values for various parameters of the AEC module 306. By way of example, the AEC module 306 may include a more aggressive mode and a less aggressive mode. The more aggressive mode may be configured to more aggressively and actively filter out the background noise compared to the less aggressive mode of the AEC module 306. That is, in the more aggressive mode, the AEC module 306 may be configured to filter out substantially all of the background noise in the audio recorded. Conversely, the less aggressive mode may be configured to less aggressively and actively filter out the background noise compared to the more aggressive mode of the AEC module 306. That is, in the less aggressive mode, the AEC module 306 may be configured to filter out only a portion of the background noise in the audio recorded.

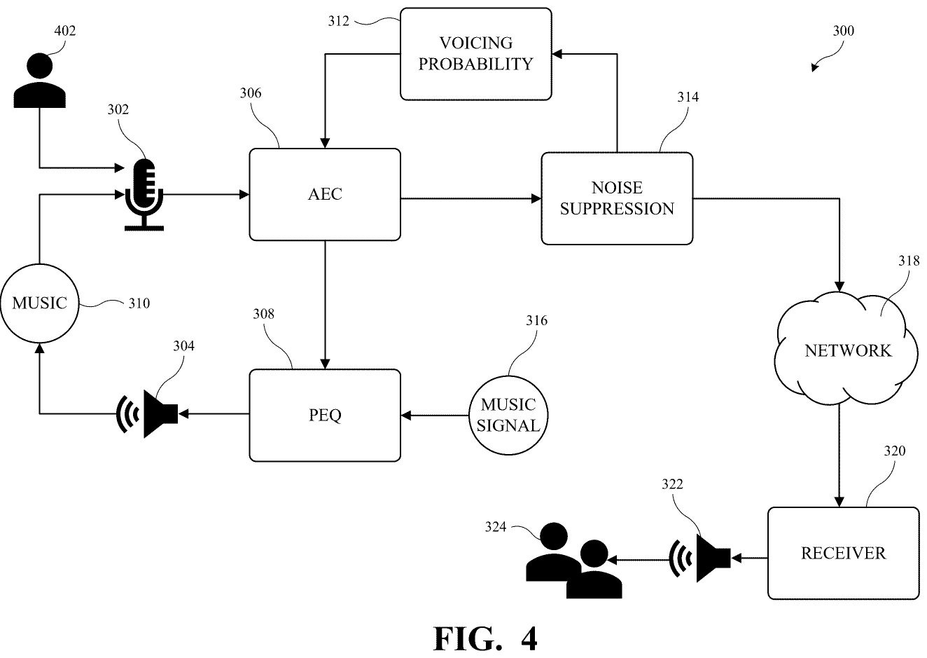

Turning back to FIG. 3, responsive to the voicing probability module 312 determining that no voice of the user is present in the audio recorded, the voicing probability module 312 may communicate with the AEC module 306 to switch the AEC module 306 into the more aggressive mode. That is, since no voice is present and at risk of being accidentally filtered out by the AEC module 306, the AEC module 306 may switch to the more aggressive mode to eliminate substantially all or all of the background noise in the audio recorded. As such, no background noise may be transmitted downstream. Switching to the less aggressive mode based upon detection of a voice will be discussed further with respect to FIG. 4.

Based upon the above filter modules of the uplink stage (e.g., the AEC module 306, the voicing probability module 312, and the noise suppression module 314), the audio recorded may be filtered in real time prior to transmission of the audio (e.g., the audio signal) to a receiver 320. That is, once the audio recorded is filtered during the uplink stage, the filtered audio may then be transmitted to the receiver 320 via a network 318. The receiver 320 may be, for example, the apparatus 106 of FIG. 1 and the network 318 may be, for example, the network 108 of FIG. 1. The audio may then be played via a playback device 322 of the receiver 320 such that an audience 324 may listen to the filtered audio, such as in real time.

For illustrative purposes, the user of the recording device 302 may be the lead singer 202 of FIG. 2 using the apparatus 102 of FIG. 1. The lead singer 202 may be silent for a portion of the recording such that only the music 310 is recorded as background noise, at which point the music 310 is filtered at via the filter modules of the uplink stage. The background noise may be substantially eliminated as discussed above such that the filtered audio sent to the receiver 320 is silent and free of the background noise. Therefore, the audience 324, which may be the audience 206 of FIG. 2, may not hear the background noise through the receiver 320.

Advantageously, the uplink stage of the system 300 (e.g., the AEC module 306, the voicing probability module 312, and the noise suppression module 314) may also communicate with a downlink stage of the system 300 to dynamically filter or otherwise adjust the music signal 316 prior to the music signal 316 being played through the playback device 304. For example, the AEC module 306 may communicate with one or more filter modules of the downlink stage, such as a perceptual equalizer (PEQ) module 308. The AEC module 306 may determine (e.g., calculate) one or more conditions, parameters, values, or a combination thereof that may be provided (e.g., transmitted) to the PEQ module 308 to adjust operation of the PEQ module 308. For example, the AEC module 306 may determine a signal-to-noise ratio (SNR) and other parameters that may be correlated to a processing capability of the AEC module 306 at different frequency bands of the music signal 316.

The AEC module 306 and/or the PEQ module 308 may operate based upon particular capability requirements. For example, the AEC module 306 and/or the PEQ module 308 may operate within particular computational resource constraints such that an overall computing power may manage both the AEC module 306 and the PEQ module 308. In such a case, the AEC module 306 may operate within (e.g., process) a portion of frequency bands (e.g., frequency bands below 8 kHZ) while leaving some frequency bands unprocessed and/or coarsely processed (e.g., frequency bands at or above 8 kHz). The PEQ module 308 may also be constrained in a manner that does not impact the actual physical perception of the audio (e.g., music signal) played through a playback device but operates within the particular computational resource constraints. For example, the PEQ module 308 may not completely attenuate the energy in particular frequency bands (e.g., may not attenuate the energy in particular frequency bands to a value of zero). Based on the above, the AEC module 306 and/or the PEQ module 308 may be adjusted or otherwise tuned based upon the computing power of the overall computing system.

It should be noted that the PEQ module 308 may be additionally, or alternatively, be a module that may adjust gain more broadly across some or all frequencies (e.g., across some or all frequency bands). For example, in certain configurations, the PEQ module 308 may be or may include functionality similar to an adaptive gain control (AGC) module. Additionally, it should be noted that operation of the PEQ module 308 may be adjusted based upon operation at the downlink stage. That is, the PEQ module 308 alone or in combination with one or more additional modules at the downlink stage may determine limitations of the PEQ module 308 such that operation of the PEQ module 308 may be adjusted.

Such determinations of the AEC module 306 may be based upon the audio recorded. For example, if the AEC module 306 determines that the SNR or other determined signal metric or ratio (e.g., signal-to-echo ratio meets a predefined threshold (e.g., is above or below the predefined threshold)), the AEC module 306 may request that the PEQ module 308 modify the music signal 316 being output by the playback device 304 to be improve (e.g., decrease) the background noise in the audio recorded. Thus, the system 300 may actively and dynamically adjust both the audio recorded at the uplink stage and the music signal 316 at the downlink stage to better improve the audio data ultimately transmitted to the receiver 320 for listening by the audience 324.

It should also be noted that the modules described above may vary in positions to alter a process flow of the system 300 and are not limited to the above description. For example, one or more of the filter modules of the uplink stage may also be located in the downlink stage, or vice versa.

FIG. 4 illustrates another example of the real-time audio communications system 300 of FIG. 3 for processing audio recordings. As discussed above, the system 300 may be implemented by a sender and/or a receiver, such as the apparatus 102, the apparatus 104, and the apparatus 106 of FIG. 1. That is, the system 300 may be part of the system 100 of FIG. 1. The system 300 may be configured for real-time audio communications, such as KTV as described with respect to FIGS. 2 and 3. However, the system 300 may be implemented for any type of real-time audio communications.

As discussed above, the system 300 may include the recording device 302, the playback device 304, the uplink stage, and the downlink stage. The uplink stage includes the AEC module 306, the voicing probability module 312, and the noise suppression module 314. As a result, audio recorded by the recording device 302 may be processed through the AEC module 306, the voicing probability module 312, the noise suppression module 314, or a combination thereof prior to sending the filtered audio to the receiver 320 via the network 318, at which point the audio may be played through the playback device 322 of the receiver 320. The audience 324 may thus listen to the recorded audio in real time.

The downlink stage may include the PEQ module 308 such that the music signal 316 may be filtered or otherwise modified prior to the music signal 316 playing through the playback device 304 to play the music 310. The playback device 304 and the recording device 302 may be part of the same device, such as the apparatus 102. As such, the system 300 may improve the overall audio quality transmitted to the receiver 320 at both the uplink stage and the downlink stage.

As discussed above, the audio recorded by the recording device 302 may include background noise caused by the music 310 playing through the playback device 304. While FIG. 3 illustrates the system 300 in an environment where a user was not actively recording their voice (e.g., a voice segment of a user singing along to the music 310), FIG. 4 illustrates an alternative scenario where a user 402 is in fact actively recording their voice. As a result, the audio recorded by the recording device 302 may include both background noise caused by the music 310 and the voice of the user 402 (e.g., the voice of a singer).

In such a scenario, the audio recording (e.g., the combined voice segment and background noise) may be initially processed through the AEC module 306 as discussed above and then processed through the noise suppression module 314. The voicing probability module 312 may then detect if a voice is present in the audio recorded. In the scenario shown in FIG. 4, the voicing probability module 312 may detect the presence of the voice of the user 402 in the audio recorded. As a result, the voicing probability module 312 may communicate to the AEC module 306 to adjust the AEC module 306 such that the AEC module 306 may operate in the less aggressive mode as described above. That is, the AEC module 306 may filter out less of the background noise to ensure that the voice of the user 402 is not also inadvertently filtered out or otherwise suppressed.

By way of example, the less aggressive mode of the AEC module 306 may be configured to filter out background noise at one or more frequency bands that are less than the frequency bands generally associated with the voice of the user 402. For example, singing voices may generally be heard and/or processed at a frequency within a particular range (e.g., about 20 Hz to about 24 kHz). As such, when the AEC module 306 operates in the less aggressive mode in that particular range, the AEC module 306 may be configured to filter out background noise in one or more frequency bands (e.g., about 0 to about 8 kHz) in a manner that preserves the singing voice recorded. That is, when operating in the less aggressive mode, the AEC module 306 may operate apply a lesser (e.g., more moderate) energy attenuation to the one or more frequency bands such to avoid inadvertently filtering out the singing voice recorded. Such operation may not be possible in the more aggressive mode of the AEC module 306, in which the AEC module 306 may apply a higher (e.g., heavier) energy attenuation to the one or more frequency bands, which may thereby also inadvertently attenuate (e.g., filter out) at least some portion of the singing voice recorded. Thus, when operating in the less aggressive mode, the AEC module 306 may be prevented from actively filtering out the voice of the user 402.

Based on the above, the background noise caused by the music 310 may be filtered out so that the voice of the user 402 (e.g., voice segment) may be transmitted to the receiver 320 without substantial interference from the background noise.

FIG. 5 is a flowchart of an example of a technique 500 for processing audio recordings. The technique 500 may be implemented by a sender, such as the apparatus 102 of FIG. 1, and/or a receiver, such as the apparatus 104 and the apparatus 106 of FIG. 1. The technique 500 may be implemented as software modules stored in the memory 112, the memory 120, and/or the memory 128 of FIG. 1 as instructions and/or data executable by the processor 110, the processor 118, and/or the processor 126 of FIG. 1, respectively. For another example, the technique 500 may be implemented in hardware as a specialized chip storing instructions executable by the specialized chip. Similarly, the technique 500 may be implemented in one or more systems, such as the system 300 of FIGS. 3 and 4.

The technique 500 may be performed by the sender and/or the receiver at each time step. For example, if the sender is transmitting audio data for playback at a rate of one audio packet every 20 milliseconds, then the technique 500 may be performed once approximately every 20 milliseconds. Similarly, the technique 500 may be performed by the sender and/or the receiver based upon a defined time duration. For example, the technique 500 may be performed by the sender and/or the receiver once every X time steps, where X may be defined as a set number of time steps. Portions of the technique 500 performed by the sender may be communicated to the receiver through a network, such as the network 108. Similarly, portions of the technique 500 performed by the receiver may be communicated to the sender through a network, such as the network 108.

As discussed above, the sender (e.g., the lead singer 202 and/or the co-singer 204 of FIG. 2, the user 402 of FIG. 4, etc.) may be configured to record audio signals, such as a voice (e.g., voice segment) of a user. Such audio recording may be completed at 502 using a recording device, such as a microphone, which may be similar to the recording device 302 of FIGS. 3 and 4. As discussed above, the audio recorded may be singing of a user that may be associated with music also played through a playback device of the sender. The audio recorded may also include background noise created by the music being played through the playback device and/or created from other external sources.

Once audio is recorded at 502, the audio (e.g., the audio signal) may be processed at an uplink at 504. For example, the uplink stage may include on or more filter modules, such as the AEC module 506 and the noise suppression module 508, whereby the audio may be filtered through such modules. The uplink stage may also include a voicing probability module 510 that may identify whether a voice of a user is present in the audio recorded. It should be noted that the AEC module 506, the noise suppression module 508, and the voicing probability module 510 may be similar to the AEC module 306, the noise suppression module 314, and the voicing probability module 312, respectively, of FIGS. 3 and 4. As discussed above, the voicing probability module 312 may dynamically and actively adjust filtering done by the AEC module 506.

The uplink stage at 504 may communicate with a downlink stage at 512. The downlink stage 512 may also include one or more filter modules, such as a PEQ module 514. The PEQ module 514 may be similar to the PEQ module 308 of FIGS. 3 and 4. The PEQ module 514—and the downlink stage as a whole—may be configured to dynamically and actively filter or otherwise manipulate a source signal, such as the music signal 316, that is ultimately played through a playback device at 516. The playback device may be similar to the playback device 304 of FIGS. 3 and 4. Additionally, as discussed above, the music played through the playback device may ultimately be recorded by the recording device at 502, as indicated by the dashed line.

The uplink stage at 504 may also transmit the filtered audio recorded (e.g., the singing) at 518 to a receiver, such as the apparatus 106 of FIG. 1 and the receiver 320 of FIGS. 3 and 4. As a result, the filtered audio recorded—that is, the audio recorded with background noise filtered out—may be ultimately played at 520. Thus, communication between the uplink stage and the downlink stage may improve the audio ultimately transmitted to the receiver at 518 and played by the receiver at 520.

FIG. 6 is a flowchart of an example of a technique 600 for processing audio recordings, such as a method for real-time processing and transmitting of an audio recording of a voice segment of a speaker (e.g., singer). The technique 600 may be implemented by a sender, such as the apparatus 102 of FIG. 1, and/or a receiver, such as the apparatus 104 and the apparatus 106 of FIG. 1. The technique 600 may be implemented as software modules stored in the memory 112, the memory 120, and/or the memory 128 of FIG. 1 as instructions and/or data executable by the processor 110, the processor 118, and/or the processor 126 of FIG. 1, respectively. For another example, the technique 600 may be implemented in hardware as a specialized chip storing instructions executable by the specialized chip.

At 602, a recording device of an apparatus (e.g., a microphone of the apparatus 102) may capture audio (e.g., an audio signal), such as singing of a user of the apparatus 102, as described with respect to KTV application above. Additionally, as described above, the audio signal recorded may also include background noise from one or more external sources and/or caused by music (e.g., an audio source) being played through a playback device (e.g., speakers) of the apparatus 102.

At 604, it may be determined at an uplink stage, by a processor, whether the audio recorded includes a voice segment of a speaker. That is, at 604, it may be determined whether singing of the user is captured in the audio signal recorded. At 606, the audio signal may be initially filtered during the uplink stage to suppress or eliminate the background noise, thereby improving the audio quality and better isolating the voice of the speaker if present. In circumstances where the voice of the speaker is not determined at 604, filtering at 606 may result in the filtered audio signal being substantially silent or otherwise free of noise.

At 608, one or more parameters associated with the audio signal may be determined by the processor, such as those discussed above with respect to FIGS. 3 and 4. For example, the AEC module 306 of the uplink stage may communicate with the PEQ module 308 of the downlink stage to modify operation of the PEQ module 308 to better improve the music signal 316 being played through the playback device 304.

Responsive to the downlink stage receiving the one or more parameters from the uplink stage, filtering of an audio source associated with the audio signal that is played through a playback device of the apparatus during capturing of the audio signal may be done at 610. The audio source may be or may include the background noise of the audio signal captured by the recording device. Additionally, the filtering may be completed at the downlink stage, such as at the PEQ module 308 of FIGS. 3 and 4, based upon the one or more parameters received from the uplink stage. The audio source may also be or include the music signal 316 or other music source that is played through the apparatus (e.g., the playback device 304 of apparatus 102), which may ultimately cause the background noise of the audio signal.

By way of example, the filtering at the downlink stage at 610 may be completed based on the teachings above with respect to FIGS. 4 and 5. For example, as discussed above, the user 402 may sing into the recording device 302 (e.g., a microphone). The microphone may thus capture an audio signal that may contain the singing of the user 402 as a voice segment. The audio signal may then be processed through one or more filter modules at the uplink stage, such as the acoustic echo cancellation (AEC) module 306 and/or the noise suppression module 314, to filter out (e.g., eliminate and/or suppress) background noise that may be present in the audio signal that was originally recorded by the recording device 302.

In particular, the background noise captured by the recording device 302 in the audio signal may be created or a result of the music 310 playing through the device of the user 402. For example, the device of the user 402 may include a speaker that plays the music 310 so that the user 402 may sing along to the music 310. However, in certain scenarios, the music 310 may be played at a higher volume that may be captured (e.g., recorded) by the recording device 302 (e.g., when the recording device 302 is part of, or in close proximity to, the speaker playing the music 310). In such a case, the music 310 creates unwanted background noise that may negatively impact the sound quality received by the audience 324 downstream. In such a case, the uplink stage filtering (e.g., the AEC module 306 and/or the noise suppression module 314) may filter out all or a portion of the background noise created by the music 310.

Additionally, to further improve the sound quality received by the audience 324 downstream, the uplink stage may communicate with the downlink stage so that the downlink stage may filter the music 310 being played through the speaker of the device of the user 402. For example, at 608, the one or more parameters associated with the audio signal recorded by the recording device 302 may be determined and ultimately communicated to the downlink stage (e.g., a stage that processes and outputs the music 310 through the device of the user 402). Such parameters may include a signal-to-noise ratio (SNR), a volume of the music 310 based upon the audio signal, other parameters, or a combination thereof.

The above parameters determined at 608 may thus be communicated to the downlink stage to filter the audio source (e.g., the music 310, which may be or may include the audio signal prior to playback through a playback device) at 610 to further improve the audio signal captured by the recording device 302. For example, based upon the aforementioned parameters, the music 310 may be filtered to apply high-pass filters, low-pass filters, band-pass filters, or a combination thereof to eliminate unwanted frequencies and/or enhance specific ranges of the music 310 when the music 310 is played through the speaker of the device of the user 402. Such filters may eliminate frequencies and/or enhance specific ranges of the music 310 such that the recording device 302 no longer captures the music 310 as background noise with the audio signal (e.g., with the singing of the user 402) or captures less of the music 310 as background noise with the audio signal (e.g., with the singing of the user 402). As a result, the audio signal captured by the recording device 302 based on dynamic adjustment of the music 310 played through the speaker of the device of the user 402 may require less filtering at the uplink stage (e.g., the AEC module 306 and/or the noise suppression module 314) to eliminate the background noise (e.g., the music 310 captured by the recording device 302).

As described above, a person skilled in the art will note that all or a portion of aspects of the disclosure described herein can be implemented using a general-purpose computer/processor with a computer program that, when executed, carries out any of the respective techniques, algorithms, and/or instructions described herein. In addition, or alternatively, for example, a special-purpose computer/processor, which can contain specialized hardware for carrying out any of the techniques, algorithms, or instructions described herein, can be utilized.

The implementations of computing devices (i.e., apparatuses) as described herein (and the algorithms, methods, instructions, etc., stored thereon and/or executed thereby) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing, either singly or in combination.

The aspects herein can be described in terms of functional block components and various processing operations. The disclosed processes and sequences may be performed alone or in any combination. Functional blocks can be realized by any number of hardware and/or software components that perform the specified functions. For example, the described aspects can employ various integrated circuit components, for example, memory elements, processing elements, logic elements, look-up tables, and the like, which can carry out a variety of functions under the control of one or more microprocessors or other control devices. Similarly, where the elements of the described aspects are implemented using software programming or software elements, the disclosure can be implemented with any programming or scripting languages, such as C, C++, Java, assembler, or the like, with the various algorithms being implemented with any combination of data structures, objects, processes, routines, or other programming elements. Functional aspects can be implemented in algorithms that execute on one or more processors. Furthermore, the aspects of the disclosure could employ any number of conventional techniques for electronics configuration, signal processing and/or control, data processing, and the like. The words “mechanism” and “element” are used broadly and are not limited to mechanical or physical implementations or aspects, but can include software routines in conjunction with processors, etc.

Implementations or portions of implementations of the above disclosure can take the form of a computer program product accessible from, for example, a computer-usable or computer-readable medium. A computer-usable or computer-readable medium can be any device that can, for example, tangibly contain, store, communicate, or transport a program or data structure for use by or in connection with any processor. The medium can be, for example, an electronic, magnetic, optical, electromagnetic, or semiconductor device. Other suitable mediums are also available. Such computer-usable or computer-readable media can be referred to as non-transitory memory or media and can include RAM or other volatile memory or storage devices that can change over time. A memory of an apparatus described herein, unless otherwise specified, does not have to be physically contained in the apparatus, but is one that can be accessed remotely by the apparatus, and does not have to be contiguous with other memory that might be physically contained in the apparatus.

Any of the individual or combined functions described herein as being performed as examples of the disclosure can be implemented using machine-readable instructions in the form of code for operation of any or any combination of the aforementioned hardware. The computational codes can be implemented in the form of one or more modules by which individual or combined functions can be performed as a computational tool, the input and output data of each module being passed to/from one or more further modules during operation of the methods and systems described herein.

The terms “signal” and “data” are used interchangeably herein. Further, portions of the computing devices do not necessarily have to be implemented in the same manner. Information, data, and signals can be represented using a variety of different technologies and techniques. For example, any data, instructions, commands, information, signals, bits, symbols, and chips referenced herein can be represented by voltages, currents, electromagnetic waves, magnetic fields or particles, optical fields or particles, other items, or a combination of the foregoing.

The word “example” is used herein to mean serving as an example, instance, or illustration. Any aspect or design described herein as “example” is not necessarily to be construed as being preferred or advantageous over other aspects or designs. Rather, use of the word “example” is intended to present concepts in a concrete fashion. Moreover, use of the term “an aspect” or “one aspect” throughout this disclosure is not intended to mean the same aspect or implementation unless described as such.

As used in this disclosure, the term “or” is intended to mean an inclusive “or” rather than an exclusive “or” for the two or more elements it conjoins. That is, unless specified otherwise or clearly indicated otherwise by the context, “X includes A or B” is intended to mean any of the natural inclusive permutations thereof. In other words, if X includes A; X includes B; or X includes both A and B, then “X includes A or B” is satisfied under any of the foregoing instances. Similarly, “X includes one of A and B” is intended to be used as an equivalent of “X includes A or B.” The term “and/or” as used in this disclosure is intended to mean an “and” or an inclusive “or.” That is, unless specified otherwise or clearly indicated otherwise by the context, “X includes A, B, and/or C” is intended to mean that X can include any combinations of A, B, and C. In other words, if X includes A; X includes B; X includes C; X includes both A and B; X includes both B and C; X includes both A and C; or X includes all of A, B, and C, then “X includes A, B, and/or C” is satisfied under any of the foregoing instances. Similarly, “X includes at least one of A, B, and C” is intended to be used as an equivalent of “X includes A, B, and/or C.”

The use of “including” or “having” and variations thereof herein is meant to encompass the items listed thereafter and equivalents thereof as well as additional items. Depending on the context, the word “if” as used herein can be interpreted as “when,” “while,” or “in response to.” The use of the terms “a” and “an” and “the” and similar referents in the context of describing the disclosure (especially in the context of the following claims) should be construed to cover both the singular and the plural. Furthermore, unless otherwise indicated herein, recitation of ranges of values herein is intended merely to serve as a shorthand method of referring individually to each separate value falling within the range, and each separate value is incorporated into the specification as if it were individually recited herein. Finally, the operations of all methods described herein are performable in any suitable order unless otherwise indicated herein or otherwise clearly contradicted by the context. The use of any and all examples, or language indicating that an example is being described (e.g., “such as”), provided herein is intended merely to better illuminate the disclosure and does not pose a limitation on the scope of the disclosure unless otherwise claimed.

This specification has been set forth with various headings and subheadings. These are included to enhance readability and ease the process of finding and referencing material in the specification. These headings and subheadings are not intended, and should not be used, to affect the interpretation of the claims or limit their scope in any way. The particular implementations shown and described herein are illustrative examples of the disclosure and are not intended to otherwise limit the scope of the disclosure in any way.

All references, including publications, patent applications, and patents, cited herein are hereby incorporated by reference to the same extent as if each reference were individually and specifically indicated as incorporated by reference and were set forth in its entirety herein.

While the disclosure has been described in connection with certain embodiments and implementations, it is to be understood that the disclosure is not to be limited to the disclosed implementations but, on the contrary, is intended to cover various modifications and equivalent arrangements included within the scope of the appended claims, which scope is to be accorded the broadest interpretation as is permitted under the law so as to encompass all such modifications and equivalent arrangements.

What is claimed is:

1. A method of processing audio, comprising:
capturing, via a recording device of an apparatus, an audio signal, wherein the audio signal includes background noise;
determining, at an uplink stage by a processor, whether the audio signal includes a voice segment of a speaker;
filtering, initially during the uplink stage, the audio signal to suppress or eliminate the background noise;
determining, by the processor, one or more parameters associated with the audio signal; and
responsive to receiving the one or more parameters, filtering, at a downlink stage and based on the one or more parameters, an audio source associated with the audio signal that is played through a playback device of the apparatus during capturing of the audio signal, wherein the audio source includes the background noise of the audio signal captured by the recording device.

2. The method of claim 1, wherein the audio source includes music played through the playback device of the apparatus, the voice segment of the speaker is data representing singing of the speaker that is associated with the music, and the filtering of the audio source at the downlink stage modifies the audio source playing through the playback device prior to the recording device capturing the audio source as background noise.

3. The method of claim 1, further comprising:
responsive to filtering the audio signal to suppress or eliminate the background noise, transmitting, in real-time, the audio signal to a receiver.

4. The method of claim 1, wherein filtering the audio signal to suppress or eliminate the background noise further includes:
responsive to determining that the audio signal includes the voice segment of the speaker, modifying the filtering of the audio signal to suppress or eliminate less of the background noise compared to the initial filtering of the audio signal.

5. The method of claim 1, wherein filtering the audio signal to suppress or eliminate the background noise further includes:
responsive to determining that the audio signal is free of the voice segment of the speaker, modifying the filtering of the audio signal to suppress or eliminate more of the background noise compared to the initial filtering of the audio signal.

6. The method of claim 1, wherein the uplink stage includes one or more filtering modules to filter the audio signal to suppress or eliminate the background noise.

7. The method of claim 6, wherein the one or more filtering modules includes an acoustic echo cancellation (AEC) module and a noise suppression module.

8. The method of claim 1, wherein the downlink stage includes a perceptual equalizer (PEQ) to filter the audio source that is played through the playback device of the apparatus.

9. The method of claim 8, wherein responsive to receiving the one or more parameters, filtering, at the downlink stage and based on the one or more parameters, an audio source associated with the audio signal that is played through a playback device of the apparatus during capturing of the audio signal further includes:
modifying one or more filtering parameters of the PEQ based upon the one or more parameters communicated from the uplink stage to the downlink stage.

10. The method of claim 9, wherein the one or more parameters communicated from the uplink stage to the downlink stage include a signal-to-noise ratio (SNR) and processing capability of the AEC module with respect to one or more frequency bands of the audio source.

11. An apparatus for processing audio, comprising:
a non-transitory memory; and
a processor configured to execute instructions stored in the non-transitory memory to:
capture, via a recording device of an apparatus, an audio signal, wherein the audio signal includes background noise;
determine, at an uplink stage by the processor, whether the audio signal includes a voice segment of a speaker;
filter, initially during the uplink stage, the audio signal to suppress or eliminate the background noise;
determine, by the processor, one or more parameters associated with the audio signal; and
responsive to receiving the one or more parameters, filter, at a downlink stage and based on the one or more parameters, an audio source associated with the audio signal that is played through a playback device of the apparatus during capturing of the audio signal, wherein the audio source includes the background noise of the audio signal captured by the recording device.

12. The apparatus of claim 11, wherein the processor is further configured to execute instructions stored in the non-transitory memory to:
responsive to filtering the audio signal to suppress or eliminate the background noise, transmit, in real-time, the audio signal to a receiver.

13. The apparatus of claim 11, wherein the processor is further configured to execute instructions stored in the non-transitory memory to:
responsive to determining that the audio signal includes the voice segment of the speaker, modify the filtering of the audio signal to suppress or eliminate less of the background noise compared to the initial filtering of the audio signal.

14. The apparatus of claim 13, wherein the processor is further configured to execute instructions stored in the non-transitory memory to:
responsive to determining that the audio signal is free of the voice segment of the speaker, modify the filtering of the audio signal to suppress or eliminate more of the background noise compared to the initial filtering of the audio signal.

15. The apparatus of claim 11, wherein the uplink stage includes one or more filtering modules to filter the audio signal to suppress or eliminate the background noise; and
wherein the one or more filtering modules includes acoustic echo cancellation (AEC) module and a noise suppression module.

16. The apparatus of claim 11, wherein the downlink stage includes a perceptual equalizer (PEQ) to filter the audio source that is played through the playback device of the apparatus.

17. The apparatus of claim 16, wherein responsive to receiving the one or more parameters, filter, at the downlink stage and based on the one or more parameters, the audio source associated with the audio signal that is played through the playback device of the apparatus during capturing of the audio signal further includes instructions to:
modify one or more filtering parameters of the PEQ based upon the one or more parameters communicated from the uplink stage to the downlink stage.

18. The apparatus of claim 17, wherein the one or more parameters communicated from the uplink stage to the downlink stage include a signal-to-noise ratio (SNR) and processing capability of the AEC module with respect to one or more frequency bands of the audio source.

19. A non-transitory computer-readable storage medium configured to store computer programs for processing audio, the computer programs comprising instructions executable by a processor to:
capture, via a recording device of an apparatus, an audio signal, wherein the audio signal includes background noise;
determine, at an uplink stage by a processor, whether the audio signal includes a voice segment of a speaker;
filter, initially during the uplink stage, the audio signal to suppress or eliminate the background noise;
determine, by the processor, one or more parameters associated with the audio signal; and
responsive to receiving the one or more parameters, filter, at a downlink stage and based on the one or more parameters, an audio source associated with the audio signal that is played through a playback device of the apparatus during capturing of the audio signal, wherein the audio source includes the background noise of the audio signal captured by the recording device.

20. The non-transitory computer-readable storage medium of claim 19, wherein the computer programs further comprise instructions executable by the processor to:
responsive to filtering the audio signal to suppress or eliminate the background noise, transmit, in real-time, the audio signal to a receiver, wherein the audio source includes music played through the playback device of the apparatus and the voice segment of the speaker is data representing singing of the speaker that is associated with the music.
